(19) United States
(12) Patent Application Publication
(10) Pub. No.: US 2011/0252586 A1
(43) Pub. Date: Oct. 20, 2011

(54) Automotive Cleaning System

(75) Inventors: Pieter Schouten, Topeka, CA (US); Marcus Gooden, Emporia, CA (US)

(73) Assignee: HOPKINS MANUFACTURING CORPORATION, Emporia, KS (US)

(21) Appl. No.: 13/090,020

(22) Filed: Apr. 19, 2011

Related U.S. Application Data
(60) Provisional application No. 61/325,684, filed on Apr. 19, 2010.

(51) Int. Cl. B60S 3/04

(52) U.S. Cl. 15/105; 15/111; 15/114; 15/229.11

(57) ABSTRACT

An automotive washing system comprising a soft automotive cleaning material with an incorporated tool. The cleaning tool can comprise a scraper tool, a detail brush, a seam cleaner tool, a vent and seam brush, or a stiffener tool, among many other types of tools. Each tool can be incorporated into a pocket or inverted corner of the soft cleaning material, thereby protecting the automotive surfaces from the hard edges of the cleaning tool.

### CROSS-REFERENCE TO RELATED APPLICATIONS

The present application claims priority to U.S. Provisional Patent Application No. 61/325,684, filed on Apr. 19, 2010, and entitled “Automotive Cleaning System,” the content of which is relied upon and incorporated herein by reference in its entirety.

### BACKGROUND OF THE INVENTION

1. Field of the Invention

The present invention relates to automotive washing systems, and, more specifically, to hand-held automotive washing towels with built-in tools.

2. Description of the Related Art

An automobile is traditionally washed using an absorbent cleaning material such as chenille, terrycloth (natural cotton), microfiber, or cellular material, or similar fabric that is useful for safely and gently washing a car's surface. The absorbent cleaning material is often supplemented with a cleaning solution or a slightly more abrasive fabric material, such as mesh netting or microfiber, that may be used to remove more adhered debris on the automobile's interior or exterior surfaces.

To clean the automobile, a surface is optionally pre-soaked with a cleaning solution and then wiped clean with the absorbent cleaning material, thereby removing the dirt, dust, or debris. While effective for washing automobiles, the typical system explained herein suffers certain drawbacks. For instance, there are many gaps, crevices, and surfaces on an automobile that quickly collect dust, dirt and debris but are not easily accessible to an absorbent cleaning material. An automobile's vent, for example, is difficult to access for cleaning. Often, cleaning a vent requires a separate tool such as a brush. In addition, automobiles often have crevices or seams that form where segments or components of the automobile come together. While these crevices can quickly collect dirt, dust, and debris, they are not easily cleaned using a cleaning material.

Further, while an individual cleaning the automobile may have available both an absorbent cleaning material and a tool such as a brush for cleaning, alternating between the cleaning material and the tool when each is needed can be both frustrating and time-consuming; for example, tools are easily dropped or misplaced. There is a need for an automobile cleaning system in which an absorbent cleaning material and one or more cleaning tools that reduce the amount of time needed to clean an automobile.

### BRIEF SUMMARY OF THE INVENTION

It is therefore an object and advantage of the present invention to provide a hand-held automotive washing system that can be used to clean the many different types of surfaces found in or on an automobile.

It is another object and advantage of the present invention to provide a comprehensive automobile cleaning system comprising an absorbent cleaning material with one or more incorporated cleaning tools.

It is a further object and advantage of the present invention to provide a soft washing material with a cleaning tool adapted to clean multiple surfaces of an automobile.

Other objects and advantage of the present invention will in part be obvious, and in part appear hereinafter.

In accordance with the foregoing objects and advantages, the present invention provides an automotive washing system for cleaning or detailing an automobile. The system comprises: (i) a wash implement composed of a fabric and having an outer edge; (ii) a first automobile cleaning implement disposed on a first region of the outer edge of the wash implement; and (iii) a second automobile cleaning implement disposed on a second region of the outer edge of the wash implement. In a preferred embodiment, at least one surface of the wash implement is composed of a soft material such as cotton, chenille, microfiber, cellular material, or a mixture thereof. Alternatively, the wash implement can be composed of a soft material on one side and an abrasive material such as nylon mesh on the other side. The wash implement can also include a pocket sized to fit a user's hand. The automobile cleaning implements optionally comprise a gripping surface that is shaped to ergonomically conform to a user's hand. Further, the automobile cleaning implements can be composed of either a rigid or pliable material, depending upon the intended use. The automobile cleaning implements optionally comprise a first means of attachment, such as an opening disposed through a portion of the first automobile cleaning implement, by which they are attached to the wash implement.

According to a second aspect of the invention is provided an automotive washing system for cleaning or detailing comprising: (i) a wash implement composed of a fabric and having an outer edge; (ii) a first automobile cleaning implement disposed on a first region of the outer edge of the wash implement; (iii) a second automobile cleaning implement disposed on a second region of the outer edge of the wash implement; (iv) a third automobile cleaning implement disposed on a third region of the outer edge of the wash implement; and (v) a fourth automobile cleaning implement disposed on a fourth region of the outer edge of the wash implement.

According to a third aspect of the invention is provided an automotive washing system for cleaning or detailing, wherein the first, second, third, and/or fourth automobile cleaning implements are capable of movement between a first position and a second position, wherein in the first position the automobile cleaning implement is folded back against the wash implement, and in the second position the automobile cleaning implement extends outwardly from the outer edge of the wash implement. When the automobile cleaning implements are in their first positions, a user can use the wash implement without damaging a surface of the automobile.

### BRIEF DESCRIPTION OF THE SEVERAL VIEWS OF THE DRAWING(S)

The present invention will be more fully understood and appreciated by reading the following Detailed Description in conjunction with the accompanying drawings, in which:

FIG. 1 is a front view of an automotive scraper tool according to one embodiment of the present invention;

FIG. 2 is a perspective view of the automotive scraper tool of FIG. 1;

FIG. 3 is a front view of the automotive scraper tool of FIG. 1 affixed to an automotive cleaning towel;

FIG. 4 is a top view of an alternate embodiment of a scraper tool;

FIG. 5A is a top view of an angled scraper tool according to one embodiment of the present invention;

FIG. 5B is a side view of the scraper tool of FIG. 15A;

FIG. 6A is a top view of a detail brush tool according to one embodiment of the present invention;

FIG. 6B is a side view of the detail brush tool of FIG. 16A.

FIG. 7 is a front view of an automotive seam cleaner tool according to one embodiment of the present invention;

FIG. 8 is a reverse view of the automotive seam cleaner tool of FIG. 7;

FIG. 9 is a side view of the automotive seam cleaner tool of FIG. 7;

FIG. 10 is a front view of the automotive seam cleaner tool of FIG. 5 affixed to an automotive cleaning towel, where the seam cleaner tool is retracted;

FIG. 11 is a front view of the automotive seam cleaner tool of FIG. 5 affixed to an automotive cleaning towel, where the seam cleaner tool is extended;

FIG. 12 is a front view of an automotive vent and seam brush tool according to one embodiment of the present invention;

FIG. 13 is a perspective view of the vent and seam brush tool of FIG. 9;

FIG. 14 is a side view of the vent and seam brush tool of FIG. 9;

FIG. 15 is a front view of the automotive vent and seam brush tool of FIG. 9 affixed to an automotive cleaning towel; and

FIG. 16 is a front view of a stiffener tool affixed to an automotive cleaning towel according to one embodiment of the present invention.

### DETAILED DESCRIPTION OF THE INVENTION

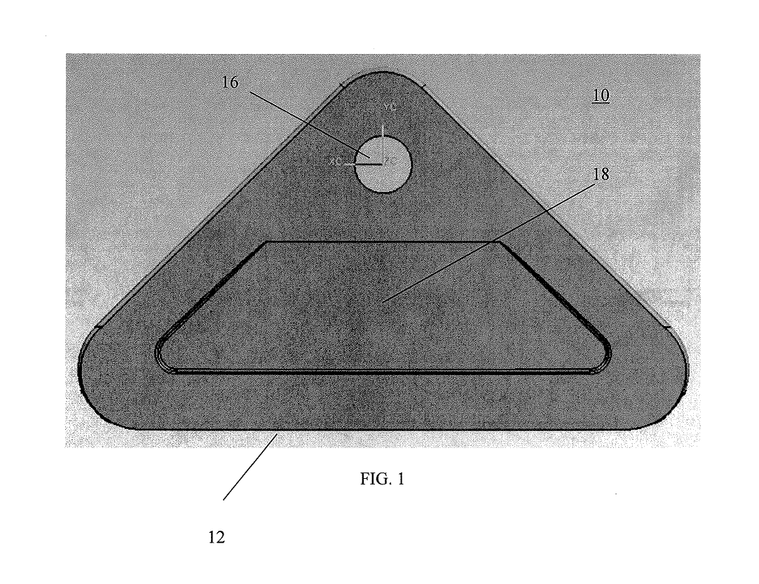

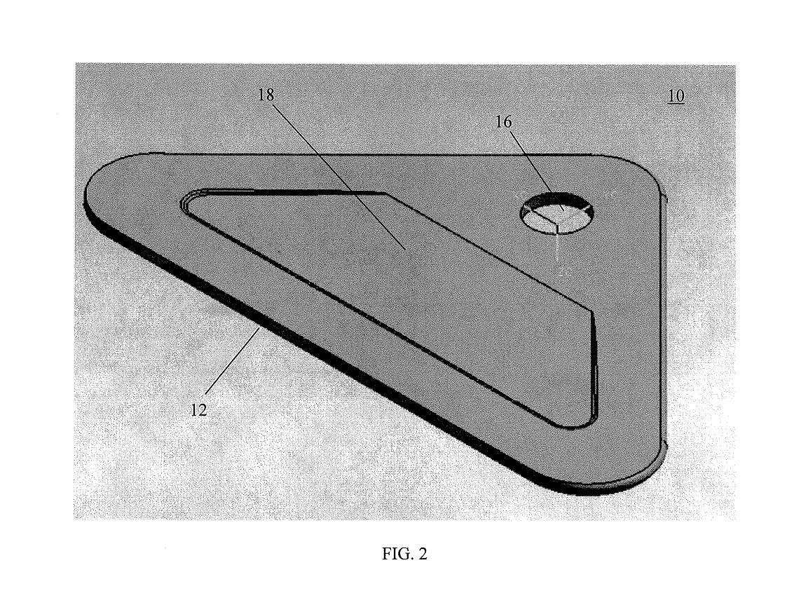

Referring now to the drawings, wherein like reference numerals refer to like parts throughout, there is seen in FIGS. 1-3 an automotive scraper tool according to one embodiment of the present invention, referred to generally by reference numeral 10. Scraper tool 10 generally comprises a triangular-shaped tool composed from a single piece of hard material, as shown in FIG. 1. The hard material can be anything that gives scraper 10 sufficient rigidity to be used as a scraping tool, including but not limited to plastic, metal, rubber, and other materials. Scraper tool 10 further comprises scraping edge 12, which is optionally rounded to facilitate scraping. The triangular shape of the scraper conforms with the shape of a user's hand, wherein the scraper is preferably gripped between the user's thumb and fingers, with the front surface 18 of the scraper gripped by the user's thumb and the reverse surface 20 gripped by the fingers. The user aligns scraping edge 12 against a surface to be scraped and pushes down on surface 18 with the thumb to force the scraping edge along the surface to be scraped.

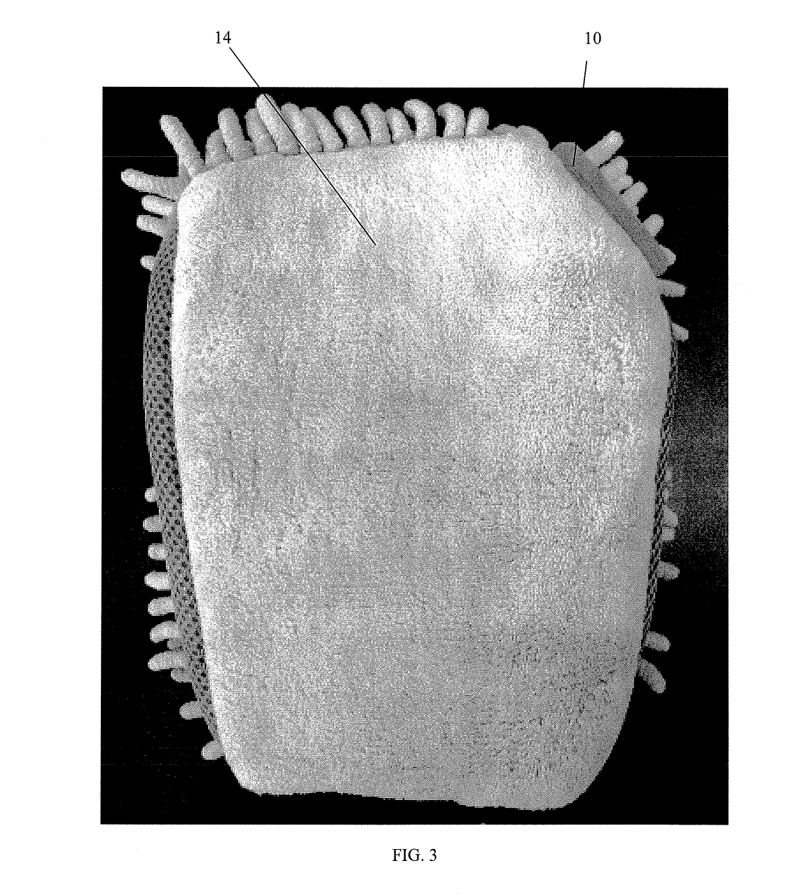

Scraper tool 10 can be connected to or integrated into a soft cleaning material such as an automotive cleaning towel 14 as shown in FIG. 3. In one embodiment, automotive cleaning towel 14 is entirely composed of a unitary material, such as chenille, terrycloth (natural cotton), microfiber, or cellular material, or similar fabric, that is useful for safely and gently washing a car's surface. In another embodiment, automotive cleaning towel 14 may be composed of both a soft material and a more abrasive material, such as nylon mesh or other woven material, that facilitates removal of debris, such as bugs, from an automobile. To integrate the scraper into automotive cleaning towel 14, scraper 10 includes a opening 16 disposed through the scraper. The scraper is then sewn or affixed by a mechanical fastener (not shown) that pierces through the soft material and the scraper.

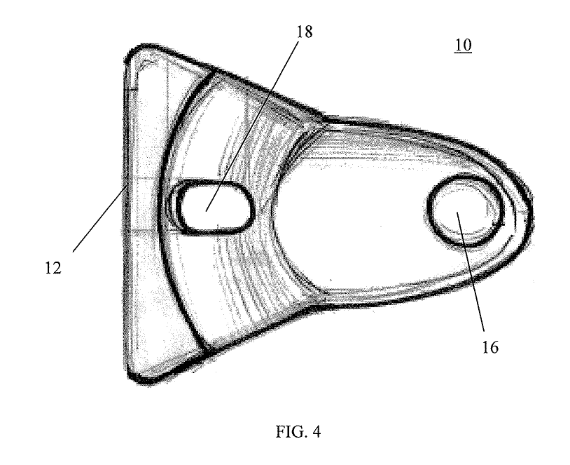

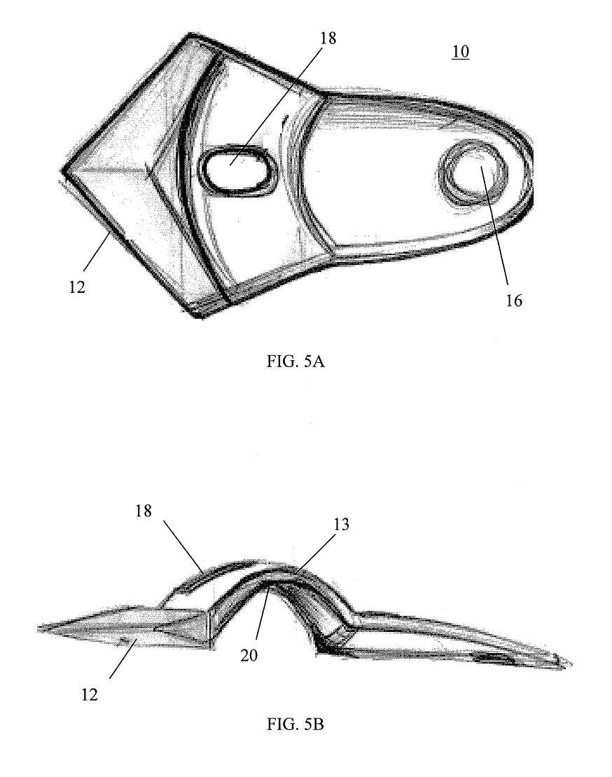

FIGS. 4-5B depict two additional alternate embodiments of scraper tool 10. The first embodiment, shown in FIG. 4, has a flat edge 12, while the second embodiment, shown in FIGS. 5A and 5B, has a pointed edge 12. These scraper tools are typically composed from a single piece of hard or flexible material, as shown in FIG. 1, although it may be composed of several pieces joined together during manufacture. The material can be anything that gives scraper 10 sufficient rigidity to be used as a scraping tool, including but not limited to plastic, metal, rubber, and other materials.

As shown in FIG. 5B, scraper tool 10 can optionally comprise a “hump” 13 which is ergonomically designed to fit into a user's hand. The shaped tool conforms with the shape of a user's hand, wherein the scraper is preferably gripped between the user's thumb and fingers, with surface 18 of the scraper gripped by the user's thumb and the reverse surface 20 gripped by one or more fingers. The user aligns scraping edge 12 against a surface to be scraped and pushes down on surface 18 with the thumb to force the scraping edge along the surface to be scraped.

As with the first embodiment of scraper tool 10, the embodiments shown in FIGS. 4-5B can be connected to or integrated into a soft cleaning material such as an automotive cleaning towel 14 using an opening 16 disposed through the scraper.

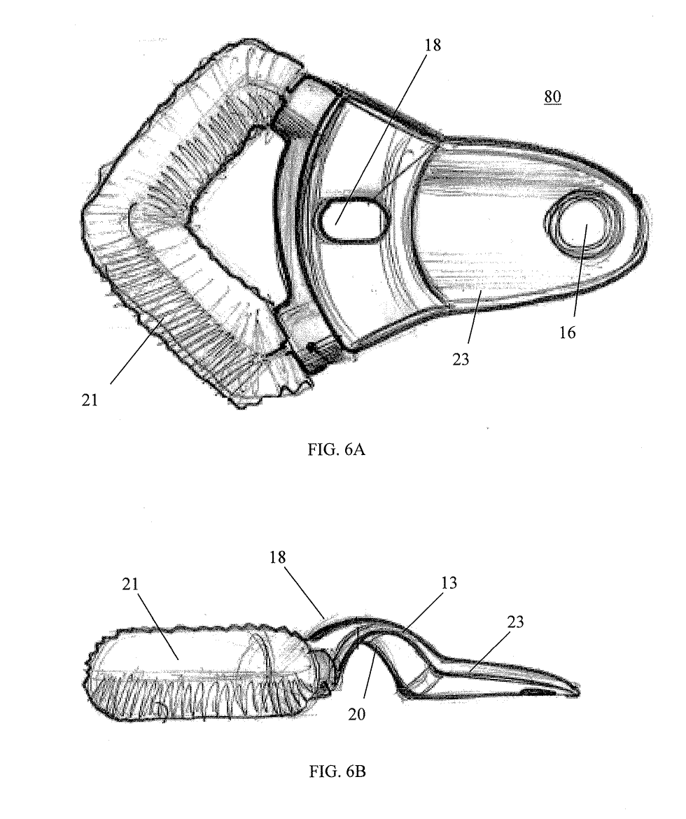

FIGS. 6A and 6B depict an automotive detail brush tool according to one embodiment of the present invention, referred to generally by reference numeral 80. Detail brush tool 80 generally comprises a triangular-shaped brush 21 affixed to or extending outwardly from a base structure 23, although any other shape for the brush is possible. Detail brush 21 is comprised of any material suitable for brushing a surface or crevice, including but not limited to abrasive brushing materials.

As shown in FIG. 6B, detail brush tool 80 can optionally comprise a “hump” 13 which is ergonomically designed to fit into a user's hand. The shaped tool conforms with the shape of a user's hand, wherein the brush is preferably gripped between the user's thumb and fingers, with surface 18 of the brush gripped by the user's thumb and the reverse surface 20 gripped by one or more fingers. The user aligns the brush 21 against or near a surface to be brush and pushes down on surface 18 with the thumb to brush the surface.

Detail brush tool 80 can be connected to or integrated into a soft cleaning material such as an automotive cleaning towel 14. In one embodiment, automotive cleaning towel 14 is entirely composed of a unitary material, such as chenille, terrycloth (natural cotton), microfiber, or cellular material, or similar fabric, that is useful for safely and gently washing a car's surface. In another embodiment, automotive cleaning towel 14 may be composed of both a soft material and a more abrasive material, such as nylon mesh or other woven material, that facilitates removal of debris, such as bugs, from an automobile. To integrate the scraper into automotive cleaning towel 14, brush 80 includes a opening 16 disposed through base structure 23. The brush is then sewn or affixed by a mechanical fastener (not shown) that pierces through the soft material and the brush.

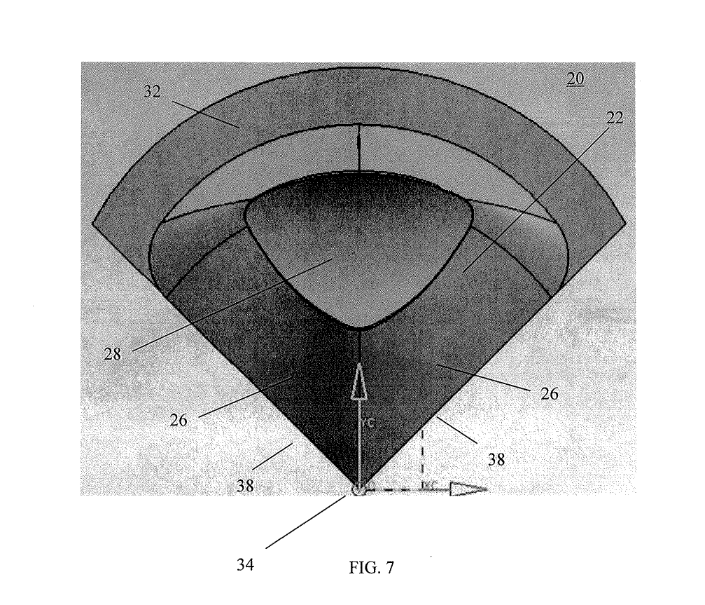

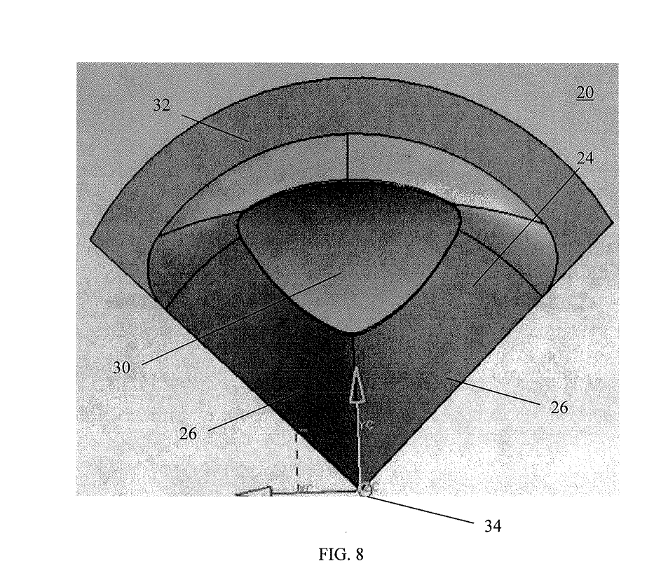

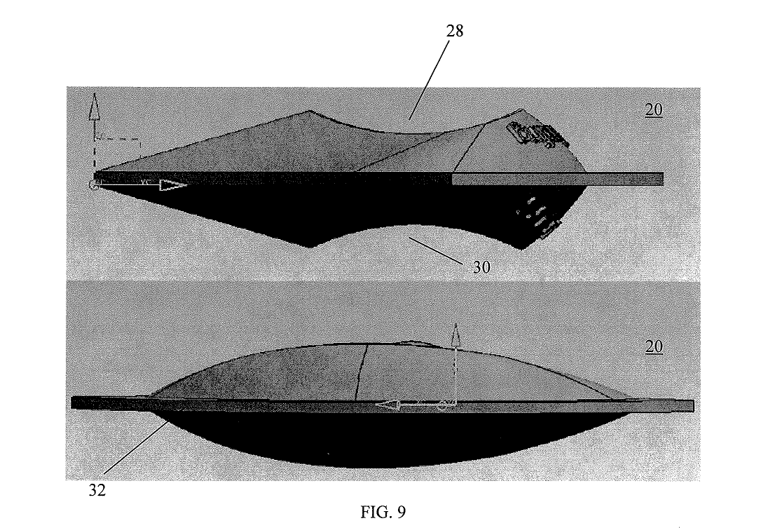

FIGS. 7-11 depict an automotive seam cleaner tool according to one embodiment of the present invention, referred to generally by reference numeral 20. Seam cleaner tool 20 generally comprises a triangular-shaped tool composed from a single piece of material. The material can be anything that gives seam cleaner tool 20 sufficient rigidity to remove debris from vents and seams in an automobile, including but not limited to plastic, metal, rubber, and other materials. Seam cleaner tool 20 comprises a first surface 22, a reverse surface 24, a pointed cleaning edge 26, and a rear connecting edge 32. First surface 22 defines a first recess 28, and reverse surface 24 defines a second recess 30. The triangular shape of the seam cleaner conforms with the shape of a user's hand, wherein the seam cleaner is preferably gripped between the user's thumb and fingers, with the user's thumb generally fitting into recess 28 in first surface 22, and the middle knuckle of the user's first finger generally fitting into recess 30 in reverse surface 24. The user grips the seam cleaner as described and aligns the pointed cleaning edge 26 with a seam or vent surface for cleaning.

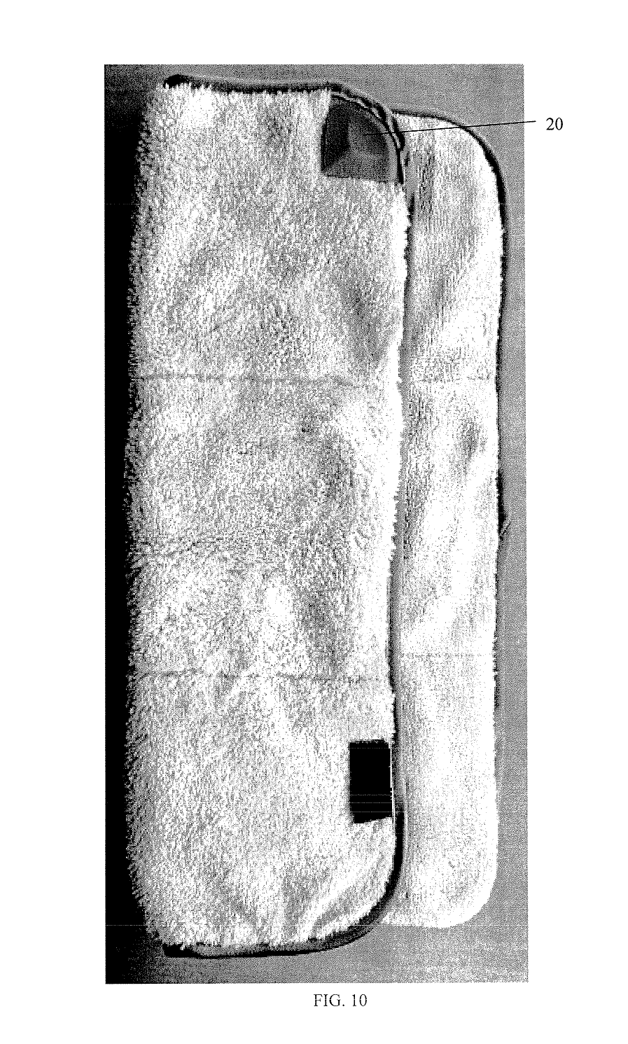

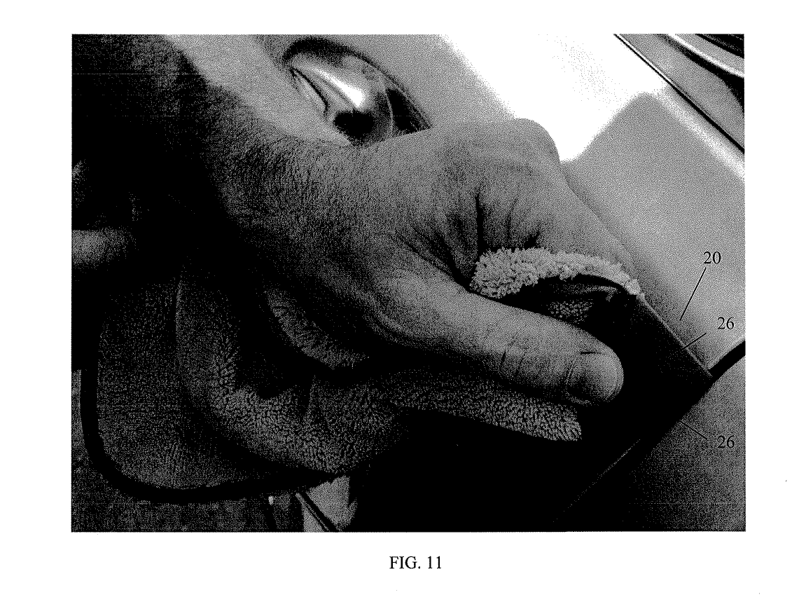

Seam cleaner tool 20 can be connected to or integrated into a soft cleaning material such as an automotive cleaning towel 14 as shown in FIGS. 10 and 11. In one embodiment, automotive cleaning towel 14 is entirely composed of a unitary material, such as chenille, terrycloth (natural cotton), microfiber, or cellular material, or similar fabric, that is useful for safely and gently washing a car's surface. In another embodiment, automotive cleaning towel 14 may be composed of both a soft material and a more abrasive material, such as nylon mesh or other woven material, that facilitates removal of debris, such as bugs, from an automobile. To integrate seam cleaner 20 into automotive cleaning towel 14, the seam cleaner includes a rear connecting edge 32 which is sewn or affixed by a mechanical fastener to the soft towel material. Once connected, the seam cleaner can assume one of two configurations. In the first configuration, which is shown in FIG. 10, the seam cleaner is folded towards the center of the towel for storage. In the second configuration, which is shown in FIG. 11, the seam cleaner is folded outward and pointed cleaning edge 26 is used to remove debris from seams and vents in the automobile. Pointed cleaning edge 26 comprises tip 34 and two forward surfaces 36 and 38 that gradually narrow from a first thickness to a second, narrower thickness that allows the front edge to be inserted into seams of variable widths. Tip 34 of pointed cleaning edge 26 can be rounded to facilitate removal of debris.

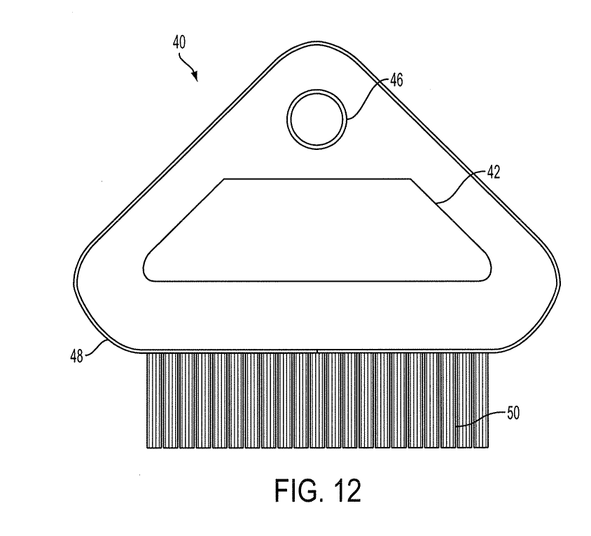

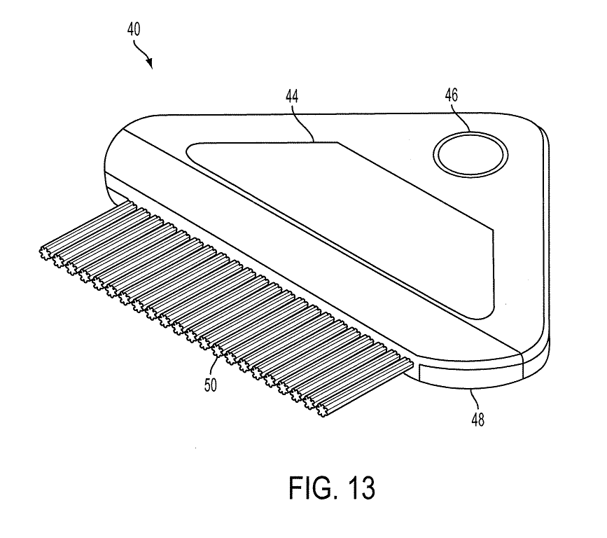

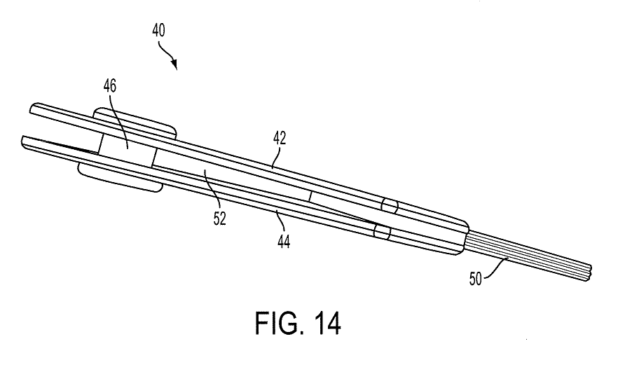

FIGS. 12-15 depict an automotive vent and seam brush according to one embodiment of the present invention, referred to generally by reference numeral 40. Vent and seam brush 40 generally comprises a triangular-shaped tool composed from hard material. The hard material can be anything that gives vent and seam brush 40 sufficient rigidity for force to be applied by the user, including but not limited to plastic, metal, rubber, and other materials. As shown in FIG. 14, vent and seam brush 40 comprises at least a first arm 42, a second arm 44, a connector 46, and a brush holder 48 which holds a brush 50. The triangular shape of the vent and seam brush conforms with the shape of a user's hand, wherein the vent and seam brush is preferably gripped between the user's thumb and fingers, with first arm 42 gripped loosely by the user's thumb and second arm 44 gripped loosely by the user's fingers, or vice versa. The user aligns brush 50 of the tool against a surface to be cleaned and applies force to rub the brush against the surface to remove debris.

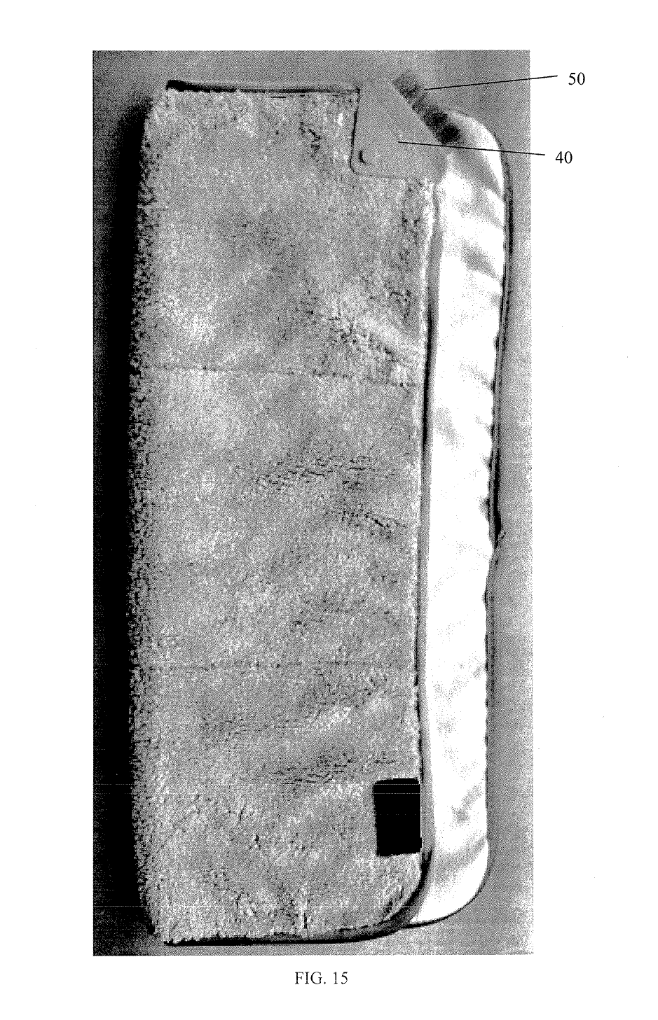

Vent and seam brush 40 can be connected to or integrated into a soft cleaning material such as an automotive cleaning towel 14 as shown in FIG. 15. In one embodiment, automotive cleaning towel 14 is entirely composed of a unitary material, such as chenille, terrycloth (natural cotton), microfiber, or cellular material, or similar fabric, that is useful for safely and gently washing a car's surface. In another embodiment, automotive cleaning towel 14 may be composed of both a soft material and a more abrasive material, such as nylon mesh or other woven material, that facilitates removal of debris, such as bugs, from an automobile. In a preferred embodiment, to integrate the vent and seam brush into automotive cleaning towel 14, the tool includes an opening disposed through each arm. To assemble, the towel is inserted into the gap 52 between first arm 42 and second arm 44 and a mechanical fastener is inserted through the opening in one arm, through the towel located in gap 52, and through the opening in the opposite arm.

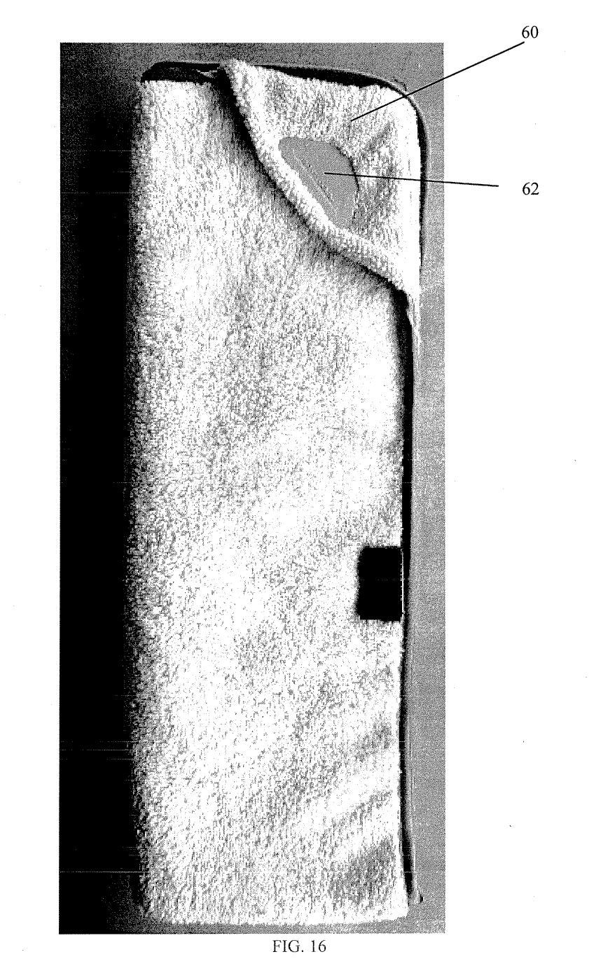

FIG. 16 depicts a stiffener tool according to one embodiment of the present invention, referred to generally by reference numeral 60. Stiffener tool 60 is composed from any stiff material which lends the tool sufficient rigidity for cleaning debris from surfaces, including but not limited to plastic, metal, rubber, and other materials. In a preferred embodiment, stiffener tool 60 is generally triangular-shaped. The triangular shape of the stiffener tool conforms with the shape of a user's hand, wherein the stiffener tool is preferably gripped between the user's thumb and fingers. The user aligns stiffener tool 60 against a surface or into a gap to be cleaned and applies force to remove debris.

Stiffener tool 60 is imbedded and/or sewn between two layers of a soft cleaning material such as an automotive cleaning towel 14 as shown in FIG. 16. In one embodiment, automotive cleaning towel 14 is entirely composed of a unitary material, such as chenille, terrycloth (natural cotton), microfiber, or cellular material, or similar fabric, that is useful for safely and gently washing a car's surface. In another embodiment, automotive cleaning towel 14 may be composed of both a soft material and a more abrasive material, such as nylon mesh or other woven material, that facilitates removal of debris, such as bugs, from an automobile. In a preferred embodiment, to integrate stiffener tool 60 into automotive cleaning towel 14, the tool is placed in a corner of the towel, covered with material, and is held in place by sewing in place or through mechanical fasteners such as fastener 62.

The washing system of the present invention includes a soft automotive cleaning material such as an automotive cleaning towel depicted in the figures, and a hard or flexible automotive cleaning tool such as scraper tool 10, seam cleaner tool 20, vent and seam brush 40, stiffener tool 60, or detail brush tool 80. In a preferred embodiment, the soft automotive cleaning material comprises two sheets or layers of a soft cleaning material that are sewn, fastened, or otherwise connected together, preferably around the edges. According to one embodiment, one layer of the two-layered cleaning material can be a soft cleaning material and the other layer can be a rougher layer. In another embodiment, the soft cleaning material is a cleaning mitt with space to receive the user's hand during cleaning.

To incorporate a tool into the two-layered soft cleaning material, one corner of the two-layered towel is inverted, thereby creating a roughly triangular-shaped pocket that receives the tool. The tool is inserted into the pocket and can be affixed inside the pocket by sewing, by mechanical fastening, by one of the mechanisms discussed previously, or through any means of affixing known in the art. Once affixed inside the pocket, only the cleaning portion of the tool—such as the scraping edge, the brush, or the seam cleaner—is exposed. Alternatively, the tool can be entirely located and/or hidden within the pocket until it is needed for cleaning. Thus, the pocket serves to hold and protect the tool, and also protects the automobile's surfaces from being damaged by the unexposed hard edges of the tool.

Alternatively, a pocket can be formed by placing the tool on a surface of a soft cleaning material such as a cleaning towel, placing a smaller piece of soft cleaning material over the tool, and then affixing both the tool and the piece of material to the towel. A pocket can also be formed in a cleaning material by removing a section of the top or bottom layer of the two-layered cleaning material, inserting the tool while leaving the cleaning portion of the tool exposed, adding a layer of the soft cleaning material over the inserted tool, and affixing the layers.

When using this cleaning system, the user can implement towel 14 in a traditional washing manner to clean any surface of an automobile. For surfaces that require scraping or debris removal, the user would adjust a towel containing scraper tool 10 such that the scraper tool is available for scraping. For surfaces that require brushing, the user would adjust a towel containing detail brush tool 80 such that the brush 21 of the tool is available for brushing. For cleaning seams, the user adjusts a towel containing seam cleaner tool 20 such that the seam cleaner tool is available for cleaning. For cleaning vents, the user adjusts a towel containing vent and seam brush 40 such that the brushing surface of the vent and seam brush is available. And lastly, for cleaning gaps or surfaces, the user adjusts a towel containing stiffener tool 60 the towel such that the stiffener tool is available for use. This system allows the user to implement a single towel to effectively and efficiently clean crevices, gaps, vents, and other interior or exterior surfaces using an automotive cleaning device.

In yet another embodiment of the present invention, the soft automotive cleaning material can include one or more of the tools, including scraper tool 10, seam cleaner tool 20, vent and seam brush 40, stiffener tool 60, and detail brush tool 80. One of the tools can be incorporated into each corner of the material, for example, or the cleaning material can include only two or three of the tools. When using this multi-tool cleaning system, the user can implement the cleaning material in a traditional washing manner to clean any surface of an automobile.

Although most shapes would be satisfactory, having the automotive cleaning device square or rectangular in shape facilitates an effective combination of towel cleaning surfaces and availability of the cleaning tool (such as scraper tool 10, seam cleaner tool 20, vent and seam brush 40, stiffener tool 60, and detail brush tool 80). Moreover, a substantial surface area of the towel provides an effective amount of washing surface area.

Although the present invention has been described in connection with a preferred embodiment, it should be understood that modifications, alterations, and additions can be made to the invention without departing from the scope of the invention as defined by the claims.

What is claimed is:

1. An automotive washing system for cleaning or detailing an automobile, comprising:
a wash implement composed of a fabric and having an outer edge;
a first automobile cleaning implement disposed on a first region of said outer edge; and
a second automobile cleaning implement disposed on a second region of said outer edge.

2. The automotive washing system of claim 1, further comprising a third automobile cleaning implement disposed on a third region of said outer edge.

3. The automotive washing system of claim 2, further comprising a fourth automobile cleaning implement disposed on a fourth region of said outer edge.

4. The automotive washing system of claim 1, wherein said first and second automobile cleaning implements are selected from the group consisting of a scraper, a seam cleaner, a vent and seam brush, a stiffener, and a detail brush.

5. The automotive washing system of claim 1, wherein said first automobile cleaning implement is capable of movement between a first position and a second position, wherein in said first position said first automobile cleaning implement is folded back against said wash implement, and further wherein in said second position said first automobile cleaning implement extends outwardly from the said outer edge of said wash implement.

6. The automotive washing system of claim 5, wherein said second automobile cleaning implement is capable of movement between a first position and a second position, wherein in said first position said second automobile cleaning implement is folded back against said wash implement, and further wherein in said second position said second automobile cleaning implement extends outwardly from the said outer edge of said wash implement.

7. The automotive washing system of claim 6, wherein when said first and second automobile cleaning implements are in said first positions, a user can use said wash implement without damaging a surface of said automobile.

8. The automotive washing system of claim 1, wherein at least one of said first and second automobile cleaning implements comprises a gripping surface.

9. The automotive washing system of claim 7, wherein said gripping surface is shaped to ergonomically conform to a user's hand.

10. The automotive washing system of claim 1, wherein at least one of said first and second automobile cleaning implements is composed of a rigid material.

11. The automotive washing system of claim 1, wherein at least one of said first and second automobile cleaning implements is composed of a pliable material.

12. The automotive washing system of claim 1, wherein said wash implement is composed of a soft material.

13. The automotive washing system of claim 11, wherein said soft material is selected from the group consisting of cotton, chenille, microfiber, cellular material, and a mixture thereof.

14. The automotive washing system of claim 1, wherein said wash implement comprises a first surface composed of a soft material and a second surface composed of an abrasive material.

15. The automotive washing system of claim 12, wherein said abrasive material is nylon mesh.

16. The automotive washing system of claim 1, wherein at least one of said first and second automobile cleaning implements is attached to said wash implement using a first means of attachment.

17. The automotive washing system of claim 14, wherein said first means of attachment comprises at least an opening disposed through a portion of said first automobile cleaning implement.

18. The automotive washing system of claim 1, wherein at least one of said first and second automobile cleaning implements is of a triangular shape.

19. The automotive washing system of claim 1, wherein at least one of said first and second automobile cleaning implements comprises at least a first cleaning edge.

20. The automotive washing system of claim 1, wherein said wash implement further comprises a pocket sized to fit a user's hand.
